(19) United States
(12) Patent Application Publication
(10) Pub. No.: US 2014/0326188 A1
(43) Pub. Date: Nov. 6, 2014

(54) Pocketed Pillow Case and Pocketed Pet Bed Cover

(71) Applicant: Michael Isaac, Milford, MA (US)

(72) Inventor: Michael Isaac, Milford, MA (US)

(21) Appl. No.: 14/265,791

(22) Filed: Apr. 30, 2014

Related U.S. Application Data
(60) Provisional application No. 61/817,609, filed on Apr. 30, 2013.

(51) Int. Cl. A47G 9/02; A01K 1/035

(52) U.S. Cl. CPC A47G 9/0253; A01K 1/0353
USPC 119/28.5; 5/485

(57) ABSTRACT

A pillowcase with a first sheet, and a second sheet of approximately the same size and directly overlying the first sheet, the sheets joined together along three edges thereof but open on a fourth edge, to form a pocket that is adapted to accept a pillow. There is a third sheet having the same width as the first and second sheets but shorter in height than the first and second sheets, and a fleece sheet having the same width as the first, second and third sheets, shorter in height than the first and second sheets and longer in height than the third sheet. The fleece sheet is attached to and covers all of one face of the third sheet and a small part of the opposing face of the third sheet. The third sheet and fleece sheet overly and are attached to the top surface of the second sheet along three edges of the third sheet and fleece sheet, but are unattached and so left open along the fourth edge, to define a pocket that is lined with fleece along its entire top.

### CROSS-REFERENCE TO RELATED APPLICATION

This application claims priority to Provisional Patent Application Ser. No. 61/817,609, filed on Apr. 30, 2013.

### FIELD

This disclosure relates to a pillowcase or the like, with a built-in pocket.

### BACKGROUND

Pillowcases provide comfort to the bottom of the head but do not cover or warm other parts of the head.

### SUMMARY

A pillowcase with a pocket into which the head can fit. The pocket is open at its bottom edge, which is located proximate the middle of the pillow. The pocket is thus at the top part of the pillow. The pocket is preferably fully fleece lined to provide additional warmth and comfort. The pocket can also be created on the top surface of a pet bed cover so that pets such as dogs can crawl into the pocket. The pet bed version is preferably open along two edges rather than only one, to provide better access for the pet.

This disclosure features a pillowcase with a first sheet, and a second sheet of approximately the same size and directly overlying the first sheet. The first and second sheets are joined together along three edges thereof, but open on a fourth edge to form a pocket that is adapted to accept a pillow. There is a third sheet having the same width as the first and second sheets but shorter in height than the first and second sheets, and a fleece sheet having the same width as the first, second and third sheets, shorter in height than the first and second sheets and longer in height than the third sheet. The fleece sheet is attached to and covers all of one face of the third sheet and a small part of the opposing face of the third sheet. The third sheet and fleece sheet overly and are attached to the top surface of the second sheet along three edges of the third sheet and fleece sheet, but are unattached and so left open along the fourth edge. This creates a pocket that is lined with fleece along its entire top. The third sheet may have a height that is greater than half that of the first and second sheets.

Also featured is a pocketed pet bed cover that is constructed and arranged to have a standard pet bed that is generally rectangular and has depth fitted into the cover. The cover has a main body that has a generally parallelepiped shape such that it a pet bed fits into it, and a flap with four edges, the flap sewn to the case along two adjacent edges but not sewn on the other two edges. The flap may be lined with fleece on the inside. The top of the main body may be fleece, to present a fully fleece-lined pocket into which a pet can crawl or burrow. The fleece may be folded over the top of part of one free edge of the flap. The pocketed pet bed cover may also include one or more zippers along the two edges of the body and the flap that are sewn together, so that the body can be opened and a pet bed fitted into the cover.

### BRIEF DESCRIPTION OF THE DRAWINGS

FIG. 1 is a top view of a pocketed pillowcase in use.

FIG. 2 is an exploded cross-sectional view of a pocketed pillowcase.

FIG. 3 illustrates a pocketed pet bed cover.

### DESCRIPTION OF EXAMPLES

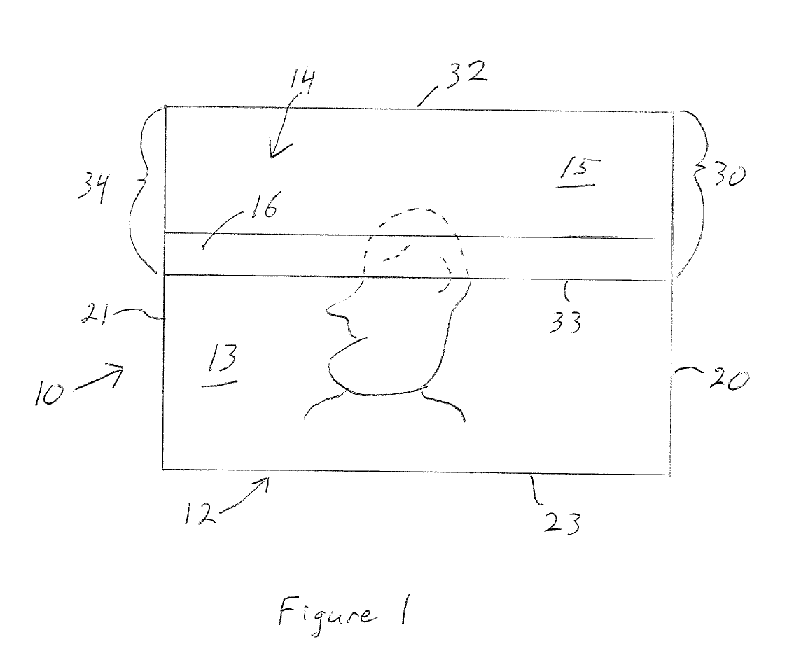

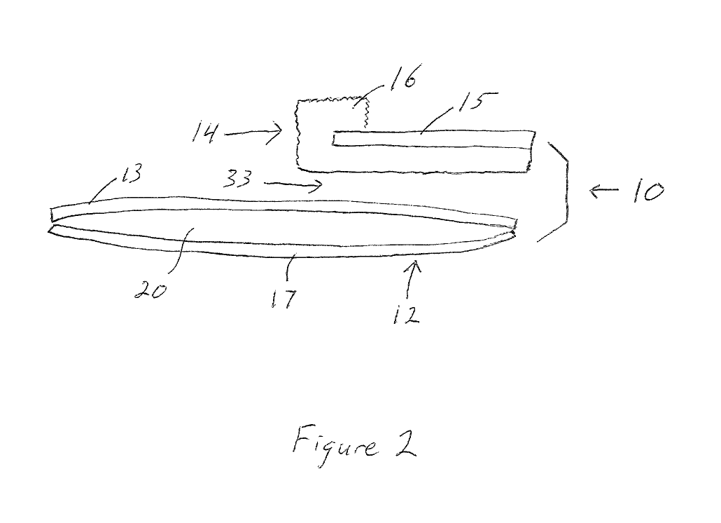

An example of a pocketed pillow case is shown in FIGS. 1 and 2, with FIG. 1 showing pocketed pillow case 10 in use and FIG. 2 showing the pocketed pillow case before it is fully assembled. Pocketed pillowcase 10 includes a first sheet 17 and a second sheet 13 that are of the same size and shape, overly one another and are sewn together along three edges, 21, 23 and 32 and left open on narrow edges 20 to define a pocket (i.e., pillowcase) 12 that is adapted to accept a pillow, as is the case with many pillowcases. Third sheet 15 has the same width as the first and second sheets but is shorter in height and extends only along length 30 and 34 that is generally either about equal to or greater than half the height of the first and second sheets. Fleece sheet 16 has the same width as the other three sheets and is slightly greater in height than the third sheet so that it can be placed against the bottom of sheet 15 and wrapped around to cover a small portion (perhaps 1-2 inches) of the top surface of sheet 15 as shown in FIG. 2, and sewn in place. This third sheet and fleece sheet combination 14 is then sewn to the top of sheet 13 along the top edge 32 and side edges 30 and 34 but left open along edge 33 to form a pocket on the top of pillowcase 12.

In use as shown in FIG. 1, a person can put his or her head into the pocket 12 defined between combination 14 and pillowcase 12, via the opening along edge 33. The pocket 12 and the fleece lining help to keep the head warm and eliminate light and sound. Also the pocket does not cover the mouth (and possibly not the nose, as shown in FIG. 1) so that it is safe to sleep in all body orientations—on the back, front and either side. Typically, the user places the head so that the nose and mouth are below the overlapping fleece section 16 so that breathing is not interrupted. See FIG. 1.

As an alternative, the pocketed pillow case can be used for pets. As another alternative, the size can be varied to accept different size pillows. Also, the opening that accepts the pillow can be on any of the four edges or even in the middle of the top or bottom sheet, as is known with traditional pillow cases. The materials can be chosen as desired. Typically, the material of the first, second and third sheets is a high quality cotton. The fleece sheet can be a thick or thin pile and can be a desired material, color and pattern.

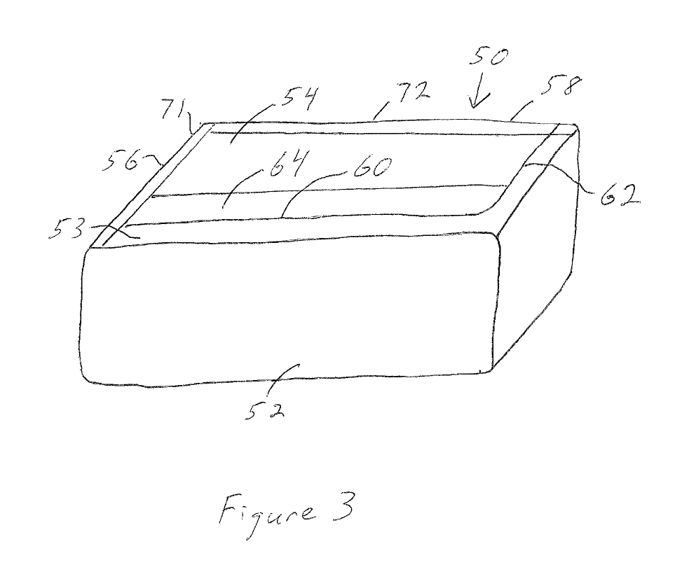

An example of use for pets is shown in FIG. 3. Pocketed pet bed cover (or case) 50 is constructed and arranged to fit over a standard foam-type pet bed that is generally rectangular and has depth. Pet beds are made in many shapes and sizes. Cover 50 can be constructed to fit over any size and shape pet bed; the shape shown in FIG. 3 is illustrative only and is not a limitation of the scope of the invention. Case 50 includes main body 52 that has a generally parallelepiped shape or other shape such that it fits relatively tightly over a pet bed in a manner similar to standard pet bed covers. Flap 54 is smaller in both dimensions than top 53 of body 52, and is sewn to case 52 along edges 56 and 58, but not sewn on the other two edges 60 and 62. Thus flap 54 creates a pocket that is open on two sides. Flap 54 can be lined with fleece on the inside. Also the top 53 of body 52 can be fleece; this presents a fully fleece-lined pocket into which a pet can burrow. The fleece can be folded over part of edge 60 as shown at portion 64, in a similar manner as shown in FIG. 2. One or more zippers 71 and 72 along edges 56 and 58 can be included, so that body 52 can be opened at the top and a pet bed can then be placed into the cover. Case 50 can be made in desired widths, lengths and depths to fit existing pet beds.

Aspects of the invention are shown in some drawings and not others, but that is not a limitation. The invention is defined by the following claims and any other claims that may be made in this or a related patent application.

What is claimed is:

1. A pillowcase, comprising:
a first sheet, and a second sheet of approximately the same size and directly overlying the first sheet, the sheets each having four edges and joined together along three edges thereof but open on a fourth edge, to form a pocket that is adapted to accept a pillow;
a third sheet having four edges and the same width as the first and second sheets but shorter in height than the first and second sheets;
a fleece sheet having four edges and the same width as the first, second and third sheets, shorter in height than the first and second sheets and longer in height than the third sheet;
wherein the fleece sheet is attached to and covers all of one face of the third sheet and a small part of the opposing face of the third sheet; and
wherein the third sheet and fleece sheet overlie part of and are attached to the top surface of the second sheet along two or three edges of the third sheet and fleece sheet, but are unattached and so left open along the other one or two of the four edges, to define a pocket that is lined with fleece along its entire top.

2. The pillowcase of claim 1 wherein the third sheet has a height that is greater than half that of the first and second sheets.

3. The pillowcase of claim 1 wherein the third sheet and fleece sheet overlie and are attached to the top surface of the second sheet along three edges of the third sheet and fleece sheet, but are unattached and so left open along the fourth edge.

4. A pocketed pet bed cover that is constructed and arranged to have a standard pet bed that is generally rectangular and has depth fitted into the cover, comprising:
a main body that has a generally parallelepiped shape such that it a pet bed fits into it;
a flap with four edges, the flap sewn to the case along two adjacent edges but not sewn on the other two edges.

5. The pocketed pet bed cover of claim 4 wherein the flap is lined with fleece on the inside.

6. The pocketed pet bed cover of claim 5 wherein the top of the main body is fleece, to present a fleece pocket into which a pet can burrow.

7. The pocketed pet bed cover of claim 6 wherein the fleece is folded over the top of part of one free edge of the flap.

8. The pocketed pet bed cover of claim 7 further comprising a zipper along the edges of the body and the flap that are sewn together, so that the body can be opened and a pet bed fitted into the cover.

9. A pillowcase, comprising:
a first sheet, and a second sheet of approximately the same size and directly overlying the first sheet, the sheets joined together along three edges thereof but open on a fourth edge, to form a pocket that is adapted to accept a pillow;
a third sheet having the same width as the first and second sheets but shorter in height than the first and second sheets, wherein the third sheet has a height that is greater than half that of the first and second sheets;
a fleece sheet having the same width as the first, second and third sheets, shorter in height than the first and second sheets and longer in height than the third sheet;
wherein the fleece sheet is attached to and covers all of one face of the third sheet and a small part of the opposing face of the third sheet; and
wherein the third sheet and fleece sheet overlie part of and are attached to the top surface of the second sheet along three edges of the third sheet and fleece sheet, but are unattached and so left open along the fourth edge, to define a pocket that is lined with fleece along its entire top.
